(19) United States
(12) Patent Application Publication
(10) Pub. No.: US 2014/0226525 A1
(43) Pub. Date: Aug. 14, 2014

(54) Safe Multicast Distribution with Predictable Topology Changes

(71) Applicant: Futurewei Technologies, Inc., Plano, TX (US)

(72) Inventors: Donald Eggleston Eastlake, III, Milford, MA (US); Sam Aldrin, Santa Clara, CA (US)

(73) Assignee: Futurewei Technologies, Inc., Plano, TX (US)

(21) Appl. No.: 14/180,080

(22) Filed: Feb. 13, 2014

Related U.S. Application Data
(60) Provisional application No. 61/764,350, filed on Feb. 13, 2013.

(51) Int. Cl. H04L 12/24

(52) U.S. Cl. CPC H04L 41/12
USPC 370/254

(57) ABSTRACT

A network node configured to manage a planned network topology change in a communication network. The communication network may comprise a first network topology, which may be employed for sending multicast and/or broadcast data to a plurality of receivers in the communication network. The planned network topology change may be applied to the first network topology and may form a second network topology. The network node may determine when the forwarding of the multicast and/or broadcast data is switched from the first network topology to the second network topology and when the forwarding of the multicast and/or broadcast data is completed on the first network topology. Subsequently, the network node may discontinue the first network topology for forwarding the multicast and/or broadcast data.

### CROSS-REFERENCE TO RELATED APPLICATIONS

The present application claims priority to U.S. Provisional Patent Application 61/764,350, filed Feb. 13, 2013 by Donald Eggleston Eastlake III, and entitled “Method for Safe Multicast Distribution with Predictable Topology Changes,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Multicast traffic may be becoming increasingly important for many Internet applications, where an information provider (e.g. source) may deliver information to multiple recipients simultaneously in a single transmission. Some examples of multicast delivery may include video streaming, real-time internet television, teleconferencing, and/or video conferencing. Multicasting may achieve bandwidth efficiency by allowing a source to send a packet of multicast information in a network regardless of the number of recipients. The multicast data packet may be replicated as required by other network elements (e.g. routers) in the network to allow an arbitrary number of recipients to receive the multicast data packet. For example, the multicast data packet may be sent through a network over an acyclic distribution tree. As such, the multicast data packet may be transmitted once on each branch in the distribution tree until reaching a fork point (e.g. with multiple receiving branches) or a last hop (e.g. connecting to multiple recipients). Then, the network element at the fork point or the last hop may replicate the multicast data packet such that each receiving branch or each recipient may receive a copy of the multicast data packet. The distribution tree may be calculated based on an initial network topology for sending the multicast traffic. However, the initial network topology may change over the duration of service, and thus causing the distribution tree to change. Consequently, the delivery of the multicast traffic on the distribution tree may be affected.

### SUMMARY

Disclosed herein are example embodiments for distributing multicast traffic without data loss during predictable network topology changes. In one example embodiment, a network node is configured to manage a planned network topology change in a communication network. The communication network may comprise a first network topology, which may be employed for sending multicast and/or broadcast data to a plurality of receivers in the communication network. The planned network topology change may be applied to the first network topology and may form a second network topology. The network node may determine when the forwarding of the multicast and/or broadcast data is switched from the first network topology to the second network topology and when the forwarding of the multicast and/or broadcast data is completed on the first network topology. Subsequently, the network node may discontinue the first network topology for forwarding the multicast and/or broadcast data.

In another example embodiment, a network element (NE) may be configured to send common data through a communication network to at least two receivers according to a first network topology. The NE may receive a planned network topology change, which may be applied to the first network topology. The NE may compute a second network topology according to the topology change. The NE may determine when the second network topology is ready for transmission. Subsequently, the NE may switch the transmission of the common data from the first network topology to the second network topology.

In another example embodiment, a network topology management node is configured to determine a planned network topology change for a first network topology that routes common data to a plurality of destinations in a communication network. The topology change may form a second network topology. When the network topology comprises adding NEs and/or links to the first network topology, the method may install the additional NEs and/or the additional links. The network topology management node may send a first message indicating the topology change in the communication network. The network topology management node may wait for the routing of the common data to be switched over to the second network topology and in-flight common data on the first network topology to be completed before removing the NEs and/or the links that are planned to be removed in the planned network topology change.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example embodiment of a network capable of sending multicast traffic.

FIG. 2 is a schematic diagram of an example embodiment of an NE.

FIG. 3 is a schematic diagram of an example embodiment of a network during a multicast topological transition.

FIG. 4 is a schematic diagram of an example embodiment of a network after a multicast topological change.

FIG. 5 is a flowchart of an example embodiment of a method for managing a planned network topology change for safe multicast distribution.

FIG. 6 is a flowchart of an example embodiment of a method for safe multicast distribution during a planned network topology change.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Multicast traffic may be an important type of transmission of network traffic, such as streaming video, real-time data delivery, and/or any other traffic that is commonly destined for multiple receivers and/or destinations. Multi-destination traffic may be sent through a network over an acyclic distribution tree, which may be calculated based on an available network topology for a corresponding type of network traffic. Distribution trees may be constructed by employing various protocols, such as the Protocol Independent Multicast (PIM) protocol as described in the Internet Engineering Task Force (IETF) documents Request For Comments (RFC) 4601, the Transparent Interconnection of Lots of Links (TRILL) as described in the RFC 6325, and/or the Shortest Path Bridging (SPB) protocol as described in the Institute of Electrical and Electronics Engineers (IEEE) 802.1.aq document, which are all incorporated herein by reference as if reproduced in their entirety. Network topologies may change over the duration of service for various reasons. Some changes may be planned (e.g. network reconfiguration, maintenance, energy conservation, policy change), and thus may be predictable, while other changes may be unanticipated (e.g. failures). When a network topology changes, a distribution tree constructed based on an initial network topology may no longer apply, and thus traffic transported using the distribution tree for delivery may experience some data loss.

Some distribution trees may include forks where a route and/or a switch may receive a packet from one port and replicate the packet into multiple copies that may be delivered to multiple output ports. Thus, every fork point in a distribution tree may be a potential multiplication port. When a routing transient occurs, temporary loops may be formed that inefficiently consume bandwidth when multiple copies of a data packet are spawned each time around the loop to produce an excessive multiplication of the data packets in the network. In some routing protocols, each data packet may comprise a hop count limit that may be decremented by one each time the data packet is forwarded by a router and/or a switch. As such, the multiplications of a data packet may be guaranteed to stop when the hop count limit reaches a value of zero. However, the duration to reach the hop count limit (e.g. about forty to fifty depending on the size of the network) may be substantially long (e.g. more than a few seconds) and the multiplications of the data packet may cause network congestion, and further data loss. Some other techniques, such as the Reverse Path Forwarding Check (RPFC) mechanism, may be employed in conjunction with routing protocols to avoid loop formations in distribution trees.

The RPFC may be performed at any switch node (e.g. switch, router, network switch equipment, etc.) in a distribution to avoid loop formations. In multicast routing, traffic filtering decisions may be determined based on a source address (e.g. a dedicated multicast routing table). When a switch node receives a multicast packet at one of the switch node's ports, the switch node may check whether the packet was received at the expected port and whether the packet was sent on an expected distributed tree according to the source that sends the packet and the switch node's view of the network topology. During normal operation (e.g. a stable network), all switch nodes in a distribution tree may have the same view of the distribution tree structure. However, during a routing transient, the distribution tree structure may be viewed differently from one switch node to another switch node. When a switch node applies the RPFC, the switch node may be able to detect a possible loop when a packet arrives at an unexpected port according to the switch node's view of the distribution tree. Upon the detection of a possible loop, the switch node may discard the packet or may stop forwarding the packet. However, the discarding of data packets as determined from the RPFC may cause substantial data loss. It should be noted that RPFC may not be required when forwarding unicast traffic with a known location and a hop count limit. Alternatively, RPFC may be applied when forwarding unicast traffic with a known location, but without a hop count limit or when forwarding unicast traffic addressed to an unknown location and thus may be forwarded to multiple destinations. Some other technologies (e.g. vMotion®) may be developed for relocating, powering up, and/or powering down servers without traffic loss, but these technologies may not be extended to network switching equipment.

Disclosed herein are various example embodiments for distributing multicast traffic during a predictable (e.g. planned or scheduled) network topology change without data loss (e.g. safe distribution). Multicast traffic may be transported through a communication network according to a first network topology. Some network topology changes, such as adding additional NEs (e.g. routers, switches) and/or links (e.g. interconnections between two NEs) and/or removing existing network elements and/or links, may be desirable for power saving, routing maintenance, policy change, and/or network expansion. In an example embodiment, a network topology change comprising adding one or more NEs and/or links to the first network topology and/or deleting one or more NEs and/or links from the first network topology may be planned. The NEs and/or the links that are planned to be added may be installed. The NEs that are in the first network topology may be notified of the upcoming network topology change. A second network topology may be calculated according to the network topology change. The second network topology may include the additional NEs and/or links and exclude the NEs and/or links that are planned to be deleted. However, the multicast traffic may continue to be forwarded on the first network topology until the second network topology is ready for transmission. After the transmission of the multicast traffic is switched over to the second network topology and the in-flight traffic on the first network topology is handled (e.g. delivered or discarded after timed out), the NEs and/or the links that are planned to be deleted may be removed and the first topology may be discontinued. The various example embodiments may ensure delivery of multicast traffic during a planned network topology change without data loss, which may otherwise occur because of conflicts between the RPFC and routing transient. In addition, persons of ordinary skill in the art are aware that the disclosure is not limited to switching from a single network topology to a single alternative network topology, but rather may be applied to any number of initial network topologies that may differ due to policies and or any other reason and may be switched over to a number of alternative network topologies.

It should be noted that the multicast distribution used by various example embodiments that are described in the present disclosure may be applied to common data traffic that is destined for multiple destinations. Common data traffic may include broadcast traffic that is addressed to all classes of stations (e.g. computers, host, etc.) connected to a network, multicast traffic that is addressed to a designated group of stations in a network, and/or unicast traffic that is addressed to a single station, but may be forwarded to multiple destinations in a network due to a unicast address with an unknown location. The various example embodiments described in the present disclosure may be applied to any planned and/or scheduled network topology changes that cause insertion and/or deletion of NEs (e.g. routers, switches) and/or links in service, but may not be applied to unanticipated changes (e.g. failures). Some examples of planned network changes may include powering off NEs to conserve energy and powering on NEs when network load increases, adding and/or removing some NEs and/or some links for route maintenance, network reconfiguration, network expansion, and/or policy change. The additions of NEs and/or links may include physical and/or logical additions of NEs and/or links. Similarly, the deletions of NEs and/or links may include physical and/or logical deletions of NEs and/or links. In one example embodiment of logical additions and/or deletions, the level of a switch in a network employing a multi-level (e.g. two levels) routing protocol, such as the Intermediate System-Intermediate System (IS-IS) protocol, may be reconfigured from a level one switch to a level two switch (e.g. adding a switch logically to a level two backbone area and deleting a switch logically from a level one area) or conversely, from a level two switch to a level one switch (e.g. adding a switch logically to a level one area and deleting a switch logically from a level two backbone area) during network expansion. In some other example embodiments, the path costs for some paths in a network may be increased to avoid a particular switch or a particular router (e.g. logically removed).

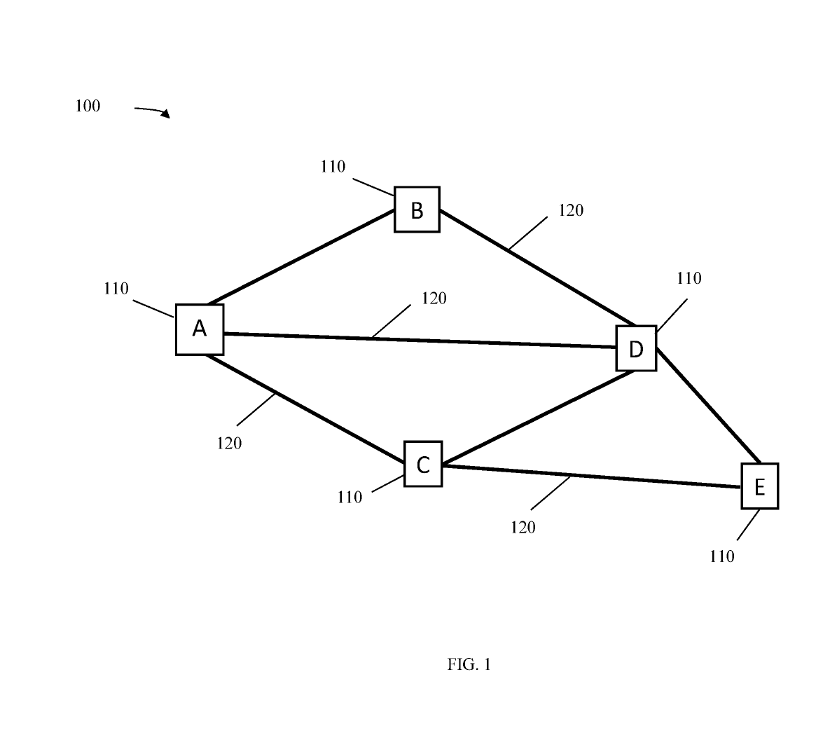

FIG. 1 is a schematic diagram of an example embodiment of a network 100 capable of sending multicast traffic. Network 100 may comprise a plurality of NEs A, B, C, D, and E 110 interconnected by a plurality of links 120. Network 100 may be formed from one or more interconnected local area networks (LANs), metropolitan area networks (MANs), wide area networks (WANs), virtual local area networks (VLANs), and/or software defined networks (SDNs). The links 120 may include physical connections, such as fiber optic links, electrical links, and/or logical connections. The underlying infrastructure of network 100 may operate in an electrical domain, optical domain, or combinations thereof. Network 100 may be configured to provide data service (e.g. unicast, multicast, broadcast), where data packets may be forwarded from one node to one or more nodes depending on traffic type. Network 100 may support one or more network topologies. For example, network 100 may support a base network topology that connects all the NEs 110 in network 100 and a plurality of other network topologies that may differ due to different multicast groups, different policies, and/or any other reasons. The network topologies may be computed from a wide variety of protocols, such as the PIM protocol, the TRILL protocol, the SPB protocol, the IS-IS protocol as described in IETF RFC 1142 and IETF RFC 5120, and the Open Shortest Path First (OSPF) protocol as described in IETF RFC 2328, IETF RFC 4915, and IETF RFC 5340, all of which are incorporated herein by reference as if reproduced in their entirety.

The NEs 110 may be any device comprising at least two ports and configured to receive data from other NEs in the network 100 at one port, determine which NE to send the data to (e.g. via logic circuitry or a forwarding table), and/or transmit the data to other NEs in the network 100 via another port. For example, NEs 110 may be switches, routers, and/or any other suitable network device for communicating packets as would be appreciated by one of ordinary skill in the art upon viewing this disclosure. The NEs 110 may be configured to forward data from a source node to one or more destination nodes (e.g. client devices) according to a network topology corresponding to the traffic type. For example, the NEs 110 and the links 120 in network 100 may represent a network topology for a particular multicast group. Network 100 may further comprise other NEs (not shown) and/or links (not shown) that belong to a base or default network topology (e.g. routes connecting every node in network 100) or some other network topologies, but may not participate in the particular multicast group. In some example embodiments, each NE 110 may be configured to compute a shortest path for each node in network 100 and subsequently may forward data according to the computed paths (e.g. store in a forwarding table). In some other example embodiments, a central management entity may be configured to compute the shortest paths (e.g. store in a forwarding table) for each NE 110 and may configure each NE 110 with the forwarding table, for example, one or more SDN controllers may act as the central management entity that configure routers in an SDN.

In an example embodiment, the PIM protocol may be employed for distributing multicast data traffic. A source node S may be connected to network (e.g. network 100) via a first hop router (e.g. NE 110) and may originate multicast data. In the PIM protocol, the first hop router may also be referred to as the root router. In order to send multicast data through the network, the source node S may first establish a multicast group G and advertise group membership information in the network. A client device connecting to the network via one of the routers (e.g. a last hop router) may receive the multicast group G information and may subsequently subscribe (e.g. join) to the multicast group G via a multicast group registration process. One of the routers (e.g. NE 110) in the network may be designated (e.g. statically or dynamically) to send periodic control messages towards the root router to track group members (e.g. joining and/or leaving). The periodic control messages may be received by other routers (e.g. NEs 110) along the path of the root router, the designated router, and/or the last hop router. As such, the other routers in the path may determine that there are downstream group members who are required to receive the multicast data from the source node S. In the PIM protocol, multicast distribution trees may be computed via a plurality of mechanisms, such as building a unidirectional or a bi-directional shared tree explicitly for all multicast groups, building a shortest path tree implicitly, or building a source-specific multicast tree per multicast group. It should be noted that the multicast groups, multicast network topologies, and/or multicast distribution may be constructed alternatively and may vary depending on the employed multicast protocols (e.g. TRILL, SPB, IS-IS, OSPF).

The various example embodiments described in the present disclosure may leverage various multi-topology (MT) routing protocols, such as the MT IS-IS protocol as described in IETF RFC 5120 or the MT OSPF protocol as described in IETF RFC 4915. Alternatively, when the network topology is determined by a VLAN, multiple topologies may be supported by classifying data packets into different VLANs. In addition to MT routing support, at least for a short period of time during a network topology change (e.g. from a first network topology to a second network topology), the data frames in-flight through the network may be marked (e.g. TRILL nicknames, Shortest Path Source Identifiers (SPsourceIDs), etc.) in order to differentiate data frames being routed on the first network topology and data frames being routed on the second network topology such that the routers and/or switches may forward the in-flight data packets accordingly. Frame markings may be achieved via multiple mechanisms and may depend on the data format and/or the employed routing protocols. For example, frame marking information may be added by allocating unused header or addressing bits, reusing some existing fields, and/or adding a new field, such as an indicator, a tag, a prefix, a suffix, and/or any other field provided that the modifications from the frame marking may be removed prior to delivering the data frames to the destinations (e.g. client devices).

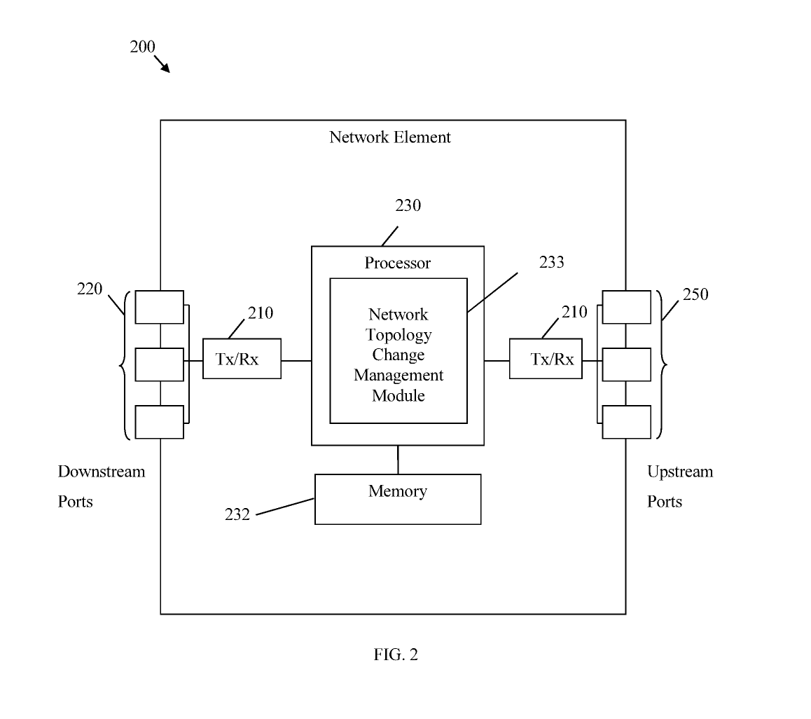

FIG. 2 is a schematic diagram of an example embodiment of an NE 200, which may include but is not limited to a router, a switch (e.g. NE 110), server, gateway, a central management entity in a network (e.g. network 100) that supports multicasting, and/or any other type of network device within a network. NE 200 may be configured to determine one or more network topologies in the network, forward data packets on the network topologies, and/or switch network topologies for data forwarding when the network topologies change. NE 200 may be implemented in a single node or the functionality of NE 200 may be implemented in a plurality of nodes. One skilled in the art will recognize that the term NE encompasses a broad range of devices of which NE 200 is merely an example. NE 200 is included for purposes of clarity of discussion, but is in no way meant to limit the application of the present disclosure to a particular NE embodiment or class of NE embodiments. Moreover, the terms network “element,” “node,” “component,” “module,” and/or other similar terms may be interchangeably used to generally describe a network device and do not have a particular or special meaning unless otherwise specifically state and/or claimed within the disclosure. At least some of the features/methods described in the disclosure may be implemented in a network apparatus or component such as an NE 200. For instance, the features/methods in the disclosure may be implemented using hardware, firmware, and/or software installed to run on hardware.

As shown in FIG. 2, the NE 200 may comprise transceivers (Tx/Rx) 210, which may be transmitters, receivers, or combinations thereof A Tx/Rx 210 may be coupled to plurality of downstream ports 220 for transmitting and/or receiving frames from other nodes, and a Tx/Rx 210 may be coupled to a plurality of upstream ports 250 for transmitting and/or receiving frames from other nodes, respectively. A processor 230 may be coupled to the Tx/Rx 210 to process the frames and/or determine which nodes to send the frames to. The processor 230 may comprise one or more multi-core processors and/or memory devices 232, which may function as data stores, buffers, etc. Processor 230 may be implemented as a general processor or may be part of one or more application specific integrated circuits (ASICs) and/or digital signal processors (DSPs). Processor 230 may comprise a network topology change management module 233, which may implement a network topology change management method 500 and/or a safe multicast distribution method 600 as discussed in more detail below. In an alternative embodiment, the network topology change management module 233 may be implemented as instructions stored in the memory devices 232, which may be executed by processor 230. The memory device 232 may comprise a cache for temporarily storing content, e.g., a Random Access Memory (RAM). Additionally, the memory device 232 may comprise a long-term storage for storing content relatively longer, e.g., a Read Only Memory (ROM). For instance, the cache and the long-term storage may include dynamic random access memories (DRAMs), solid-state drives (SSDs), hard disks, or combinations thereof.

It is understood that by programming and/or loading executable instructions onto the NE 200, at least one of the processor 230 and/or memory device 232 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

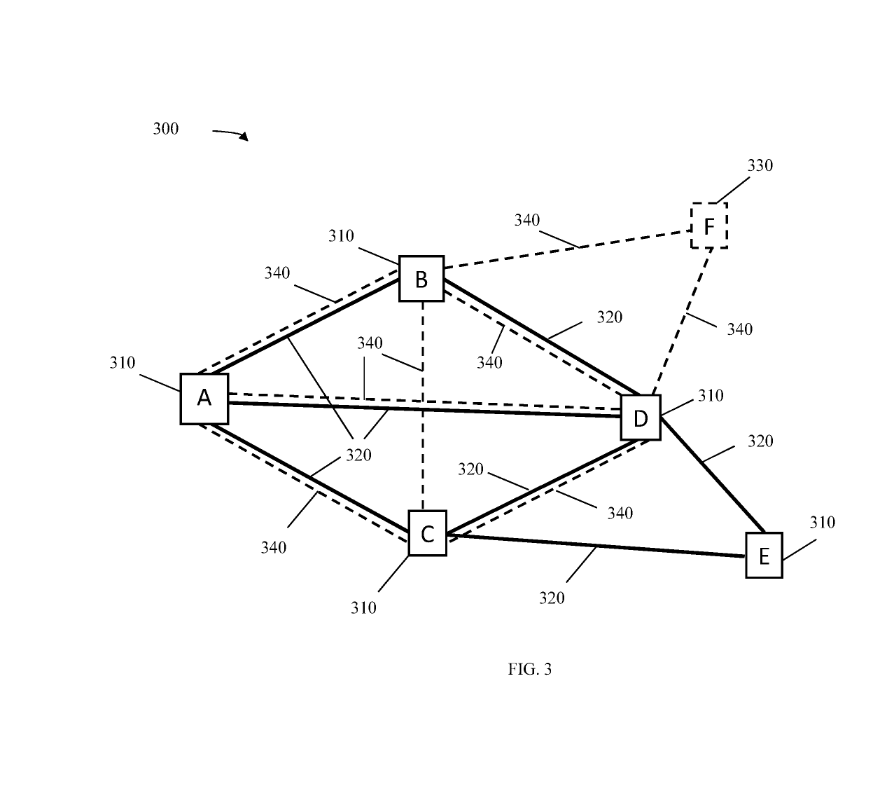

FIG. 3 is a schematic diagram of an example embodiment of a network 300 during a multicast topological transition. Network 300 may initially comprise a plurality of NEs A, B, C, D, and E 310 interconnected by a plurality of links 320, where network 300, NEs 310, and links 320 may be substantially similar to network 100, NEs 110, and links 120, respectively. The NEs 310 and links 320 (e.g. depicted as solid lines in network 300) may form a first network topology for sending multicast traffic for a particular multicast group. Network 300 may further comprise a central management entity that provides support for centralized network management operations, where the central management entity may be configured by a network administrator to manage and/or control network resources and/or operations of network 300. The network administrator may determine (e.g. predictable by planning) to re-allocate network resources in network 300. For example, the network administrator may determine to power off some NEs 310 for power savings when the traffic load is light, remove and/or add some NEs 310 and/or links 320 physically and/or logically for route maintenance and/or network reconfigurations, and/or increase link costs of some links 320 to avoid one or more particular NEs 310. It should be noted that when a physical NE or a physical link is installed and/or removed, the central management entity may receive some messages indicating the change or may detect the change. Similarly, when a logical NE or a logical link is created or deleted via some protocols or configuration tools, the central management entity may receive some messages indicating the change or may detect the change.

In an example embodiment, a central management entity may determine to reconfigure network 300 by removing NE E 310 from a first network topology, adding an NE F 330 (e.g. NE 110 or NE 310) to the first network topology and adding a link 340 (e.g. link 120 or link 320) between NE B 310 and NE C 310, and thus may change the first network topology. Recall that network topology changes may cause routing transient and substantial data loss even when RPFC is applied. When a network topology change is predictable, such as a planned or scheduled change determined by a central management entity, data loss may be avoided by some special controls and handlings. For example, the central management entity may notify the NEs 310 of the upcoming topology changes, which may indicate the removal of the NE E 310 and the addition of the NE F 330 and the link 340 between NE B 310 and NE C 310. When the NEs 310 receive the notifications, the NEs 310 may calculate a second network topology (e.g. depicted as dashed lines in FIG. 3) by including the NE F 330 and the link 340 between NE B 310 and NE C 310 and excluding the NE E 310. However, the NEs 310 may continue to route traffic through network 300 according to the first network topology and withhold from employing the second network topology until the second network topology is formed and ready for sending the multicast data. Alternatively, the central management entity may compute the forwarding paths (e.g. shortest paths) for the second network topology and configure the NE A, B, C, and D 310 and NE F 330 with forwarding tables including the shortest paths. In one example embodiment, the central management entity may install the NE F 330 and the link 340 between NE B 310 and NE C 310 prior to sending the network topology change notification. In another example embodiment, the central management entity may install the NE F 330 and the link 340 between NE B 310 and NE C 310 after sending the network topology change notification, but prior to the activation of the second network topology.

When all the NEs A, B, C and D 310 and NE F 330 complete the calculation of the second network topology and are ready to send the multicast traffic on the second network topology, the sending of the multicast traffic may be switched over to the second network topology. After waiting some duration of time such that all in-flight traffic (e.g. via the first network topology in solid lines) are handled, the central management entity may instruct the NEs A, B, C, and D 310 to discontinue the first network topology and may remove NE E 310 as planned. As such, after the network topological change is completed, the multicast traffic may be routed solely on the second network topology. It should be noted that the in-flight traffic may refer to ingress traffic that is injected into the network 300 prior to the formation of the second network topology and continues to be forwarded on the first network topology while the second network topology is activated and servicing the same type of traffic.

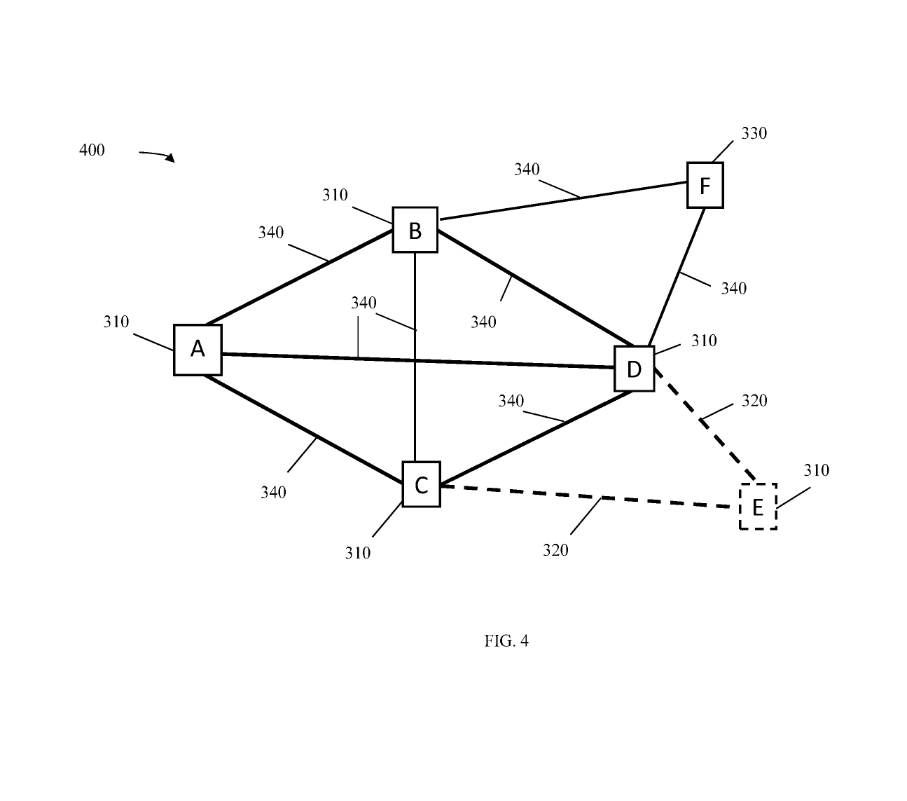

FIG. 4 is a schematic diagram of an example embodiment of a network 400 after a multicast topological change. Network 400 may comprise a multicast network topology, which may be substantially similar to the second network topology of network 300. In network 400, the solid lines may indicate a current multicast network topology (e.g. NE A, B, C, D 310, NE F 330, and links 340) in service and the dashed lines may indicate the NE (e.g. NE E 310) and links (e.g. links 320) that are removed from a previous multicast network topology.

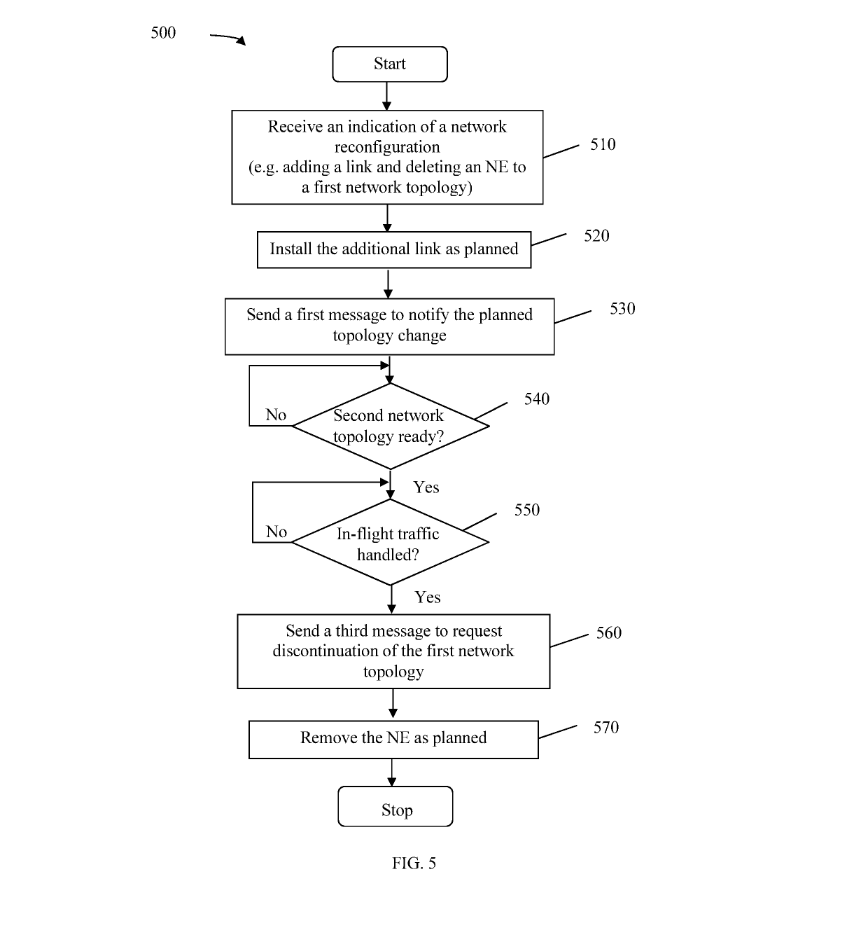

FIG. 5 is a flowchart of an example embodiment of a method 500 for managing a planned network topology change for safe multicast distribution. Method 500 may be implemented on a central management entity or an NE 200 that manages and/or controls network resources in a network (e.g. network 100 or 300). The network may comprise a first network topology for sending multicast data traffic, where the first network topology may be formed by a set of NEs (e.g. NE 110 or 310) interconnected by a plurality of links (e.g. links 120 or 320). Method 500 may begin with receiving an indication of a planned network reconfiguration (e.g. initiated by a network administrator) at step 510. For example, the network reconfiguration may include adding an additional link between two existing NEs in the first network topology and removing an existing NE from the first network topology. At step 520, method 500 may install the additional link. When the additional link is a logical connection in a virtual network or SDN, a central management entity may install the logical link through software configurations, whereas when the additional link is a physical connection in a physical network topology, the central management entity may wait for an indication that the physical link is installed prior to proceeding to step 530. At step 530, method 500 may send a message to notify the NEs of the planned topology change. In one example embodiment, method 500 may also compute the forwarding paths for the second network topology and may send a second message indicating the forwarding paths (e.g. via flow tables) to each NE in the network.

The topology change may cause the NEs to compute a second network topology accordingly. At step 540, method 500 may wait for the second network topology to be ready, for example, all the NEs may complete calculating the second network topology, all the routes for the second network topology may be exchanged between the NEs, and the second network topology may be ready for transmission. It should be noted that step 540 may be implemented via multiple methods, which may be dependent on the employed routing protocols and/or the design of the network. For example, the central management entity may monitor the NEs participating in the multicast routing and when the NEs are ready to send the multicast data traffic on the second network topology, the central management entity may request the NEs to begin routing traffic on the second network topology. Alternatively, the NEs may monitor and/or exchange link state messages with neighboring NEs that participate in the multicast routing, switch the multicast routing over to the second network topology when neighboring NEs and links are ready, and may then report the switching status (e.g. to indicate the topology switch) to the central management entity.

When the second network topology is ready and the routing of the multicast traffic is being sent on the second network topology, method 500 may proceed to step 550. At step 550, method 500 may wait for the in-flight traffic (e.g. sent via the first network topology) to be handled (e.g. delivered and/or discarded when timed out). When all the in-flight traffic is handled, method 500 may proceed to step 560. At step 560, method 500 may send a third message to request the NEs to discontinue the first network topology. Subsequently, at step 570, method 500 may remove the NE that is to be deleted as planned. The deletion may be a physical removal of the NE from a physical network or a logical deletion (e.g. via reconfiguration) from a logical network. It should be noted that the central management entity may be an independent logical entity, but may or may not be physically integrated into one of the NEs (e.g. NE 110, 310) depending on network design and/or deployment.

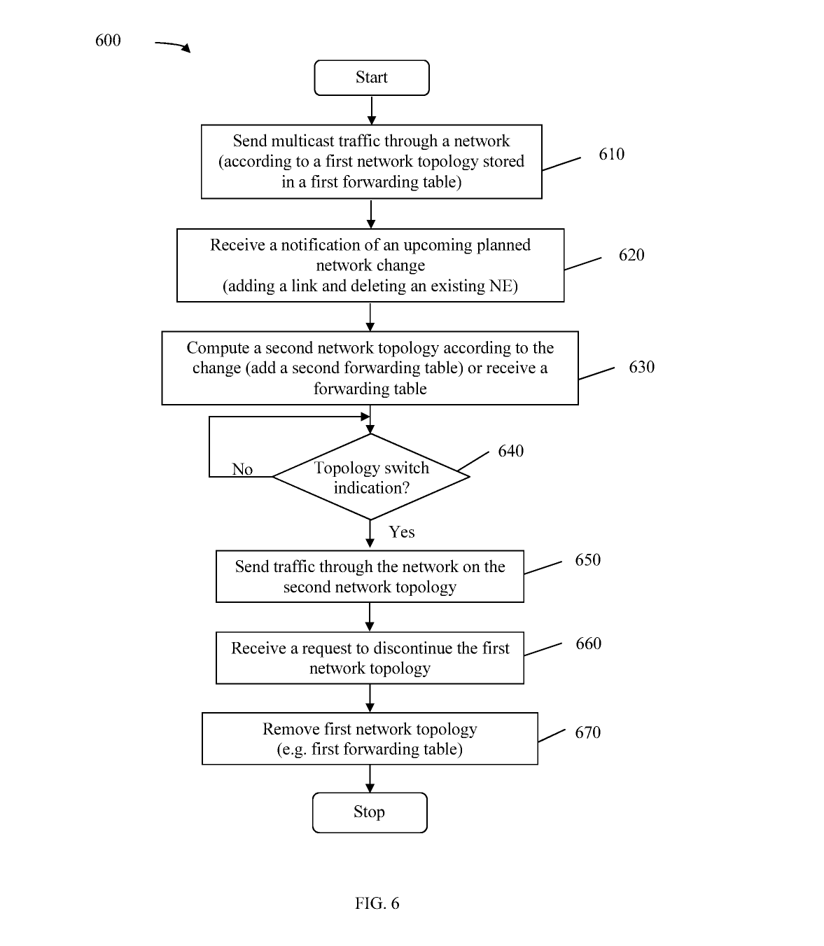

FIG. 6 is a flowchart of another example embodiment of a method 600 for safe multicast distribution during a planned network topology change. Method 600 may be implemented on an NE (e.g. NE 110, 310, or 200). Method 600 may begin with sending multicast traffic through a network (e.g. network 100 or 300) according to a first network topology at step 610, where the first network topology may be stored in a first forwarding table. At step 620, method 600 may receive a notification of an upcoming planned network topology comprising an addition of an additional link between two existing NEs in the first network topology and deleting an existing NE from the first network topology. For example, the first message may be sent by a central management entity that controls and determines the allocation of network resources in the network. Upon receiving the upcoming topology change, at step 630, method 600 may compute a second network topology according to the received topology change, where the second network topology may include the additional link and exclude the NE that is to be deleted. For example, method 600 may store the paths of the second network topology in a second forwarding table. Alternatively, method 600 may receive a forwarding table of the second network topology computed by the central management entity.

At step 640, method 600 may wait for an indication to switch the multicast routing over to the second network topology. During this waiting period, method 600 may continue to send the multicast traffic on the first network topology and withhold from sending the multicast traffic on the second network topology. It should be noted that the indication may be received via various mechanisms depending on the design and deployment of the network and/or the employed routing protocols. For example, the indication may be received from a central management entity or from other neighboring routers and/or switches participating in the second network topology (e.g. by monitoring link state messages). In an example embodiment of the IS-IS protocol, routers and/or switches may exchange IS-IS control messages (e.g. IS-IS Hello messages) over a link to indicate that the link may be employed for routing the multicast traffic for a particular topology (e.g. the second network topology). As such, routers and/or switches may determine when links to neighboring routers and/or switches may be ready for the particular topology. Similarly, routers and/or switches may determine when links to neighboring routers and/or switches for a particular topology (e.g. the first network topology) may be removed when receiving IS-IS control messages (e.g. IS-IS Hello messages) from other switches and/or routers not listing the particular topology.

Upon receiving the indication to switch multicast routing to the second network topology, method 600 may proceed to step 650. At step 650, method 600 may send the multicast traffic through the network according to the second network topology. At step 660, method 600 may receive a request to discontinue the first network topology. For example, the request may be sent from a central management entity. Thus, at step 670, method 600 may remove the first network topology (e.g. removing the first forwarding table). It should be noted that there may be some lapse of time duration between steps 650 and 660, where the time duration may be a duration where in-flight traffic (e.g. multicast traffic being serviced on the first network topology) is being handled and may vary depending on the number of hops, the size of the network, the design of the network, and/or the employed routing protocols. It should be noted that during a planned network change, any additions (e.g. routers, switches, and/or links) to the network may be installed prior to advertising the upcoming change, but any planned deletions may be removed after the second network topology is in service and the handling (e.g. delivered or timed out) of the in-flight traffic is completed.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g. from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Unless otherwise stated, the term “about” means±10% of the subsequent number. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

We claim:

1. In a network component, a method for managing a planned topology change, the method comprising:
receiving an indication for the planned topology change;
determining that the planned topology change switches transporting data traffic from a first network topology to a second network topology;
determining that no data traffic is forwarded on the first network topology; and
discontinuing using the first network topology to forward the data traffic,
wherein the data traffic is forwarded to at least two destinations in a network, and
wherein the planned topology change modifies the first network topology to form the second network topology.

2. The method of claim 1, wherein the topology change comprises at least one of the following additions: an addition of a network element to the first network topology and an addition of a link between two network elements in the first network topology.

3. The method of claim 2, further comprising detecting one of the additions before determining that the forwarding of the data traffic is switched from using the first network topology to using the second network topology.

4. The method of claim 1, wherein the topology change comprises at least one of the following deletions: a deletion of a network element from the first network topology and a deletion of a link that connects the network element with a second network element in the first network topology.

5. The method of claim 4, further comprising sending a message to request one of the deletions after discontinuing the first network topology.

6. The method of claim 1, further comprising:
sending a message to a network element that indicates the planned network topology change; and
determining that a forwarding path is calculated for the second network topology.

7. The method of claim 1, further comprising:
calculating a forwarding path of the second network topology according to the planned topology change;
sending a first message comprising the forwarding path; and
sending a second message comprising a request to switch forwarding the data traffic from the first network topology to the second network topology.

8. The method of claim 1, wherein discontinuing using the first network topology to forward the data traffic comprises sending a message comprising a request to discontinue the first network topology for forwarding the data traffic, and wherein the message is sent after the data traffic is forwarded using the first network topology.

9. The method of claim 1 further comprising:
receiving a first message indicating the planned network topology change;
computing a forwarding path of the second network topology according to the planned network topology change; and
receiving a second message comprising a request to discontinue the first network topology for the forwarding of the data traffic.

10. The method of claim 1 further comprising:
receiving a first message comprising a forwarding path of the second network topology;
receiving a second message comprising a request to switch the data traffic forwarding from using the first network topology to using the second network topology; and
receiving a third message comprising a request to discontinue using the first network topology to forward the data traffic.

11. A computer program product comprising computer executable instructions stored on a non-transitory computer readable medium such that when executed by a processor causes a network node to:
forward data traffic to at least two destinations according to a first network topology in a network;
receive a first message indicating a planned topology change of the first network topology;
compute a second network topology according to the planned topology change;
switch forwarding the data traffic from the first network topology to the second network topology;
determine that no data traffic is forwarded on the first network topology; and
discontinue using the first network topology to forward the data traffic.

12. The computer program product of claim 11, wherein the topology change comprises at least one of the following additions: an addition of a network element to the first network topology and an addition of a link between two network elements in the first network topology.

13. The computer program product of claim 11, wherein the topology change comprises at least one of the following deletions: a deletion of a network element from the first network topology and a deletion of a link that connects the network element with a second network element in the first network topology.

14. The computer program product of claim 11, wherein the instructions further cause the processor to receive a second message from a network element in the second network topology, and wherein the second message comprises a forwarding path of the second network topology.

15. The computer program product of claim 11, wherein the instructions further cause the processor to:
receive a second message from a central management entity;
receive a third message instructing the network node to send the data traffic on the second network topology; and
receive a fourth message instructing the network node to discontinue the first network topology,
wherein the second message comprises a forwarding path of the second network topology.

16. A computer program product comprising computer executable instructions stored on a non-transitory computer readable medium such that when executed by a processor causes a network node to:
send a first message indicating a planned topology change of a first network topology;
determine that the planned topology change switches transporting data traffic from the first network topology to a second network topology;
determine that no data traffic is forwarded on the first network topology; and
discontinue using the first network topology to forward the data traffic,
wherein the first network topology is used to forward the data traffic to at least two destinations in a network, and
wherein the topology change forms the second network topology.

17. The computer program product of claim 16, wherein the topology change comprises at least one of the following additions: an addition of a network element to the first network topology and an addition of a link between two network elements in the first network topology.

18. The computer program product of claim 16, wherein the topology change comprises at least one of the following deletions: a deletion of a network element in the first network topology and a deletion of a link that connects the network element to a second network element in the first network topology.

19. The computer program product of claim 16, wherein the instructions further cause the processor to send a second message after no data traffic is forwarded on the first network topology, and wherein the second message comprises an instruction to discontinue using the first network topology to forward the data traffic.

20. The computer program product of claim 16, wherein the instructions further cause the processor to:
compute a forwarding path of the second network topology;
send a second message comprising the forwarding path; and
send a third message comprising an instruction to switch forwarding the data traffic from the first network topology to the second network topology.
